(19) United States
(12) Patent Application Publication
(10) Pub. No.: US 2017/0052404 A1
(43) Pub. Date: Feb. 23, 2017

(54) DISPLAY PANEL AND DISPLAY APPARATUS USING THE SAME

(71) Applicant: SAMSUNG ELECTRONICS CO., LTD., Suwon-si (KR)

(72) Inventors: Ki Hyung KANG, Suwon-si (KR); Jeong Ho LEE, Suwon-si (KR); Maria BORTNICHENKO, Suwon-si (KR); Seung Jun JEONG, Hwaseong-si (KR)

(73) Assignee: SAMSUNG ELECTRONICS CO., LTD., Suwon-si (KR)

(21) Appl. No.: 15/228,495

(22) Filed: Aug. 4, 2016

(30) Foreign Application Priority Data
Aug. 18, 2015 (KR) 10-2015-0116021
Apr. 6, 2016 (KR) 10-2016-0042328

(51) Int. Cl. G02F 1/1333; F21V 8/00; G02F 1/1334; G02F 1/1337; G02F 1/1343; G02F 1/1335

(52) U.S. Cl. CPC G02F 1/133377; G02F 1/134336; G02F 1/133528; G02F 1/133345; G02F 1/1334; G02F 1/133514; G02F 1/133621; G02F 1/133305; G02F 1/1337; G02B 6/0068; G02F 2001/134372; G02F 2203/04; G02F 2201/123; G02F 2201/121

(57) ABSTRACT

A display panel and a display apparatus are disclosed. The display panel includes a liquid crystal capsule layer and an electrode unit. In the liquid crystal capsule layer, a plurality of liquid crystal capsules are distributed, and each of plurality of liquid crystal capsules includes liquid crystal molecules. The electrode unit disposed at one surface of the liquid crystal capsule layer forms an electric field in the liquid crystal capsule layer, wherein a thickness of the liquid crystal capsule layer exceeds half a ratio of a wavelength of incident light to a birefringence value of the liquid crystal molecules.

### CROSS-REFERENCE TO RELATED APPLICATION

This application claims the benefit of Korean Patent Application Nos. 10-2015-0116021 and 10-2016-0042328, respectively filed on Aug. 18, 2015 and Apr. 6, 2016 in the Korean Intellectual Property Office, the disclosures of which are incorporated herein by reference in their entireties.

### BACKGROUND

1. Field

Exemplary embodiments of the present disclosure relate to a display panel and a display apparatus.

2. Description of the Related Art

A display apparatus is a kind of an output device for converting acquired or stored electric information into visual information and displaying the visual information for user recognition, such that the display apparatus has been widely used in various technology fields such as households or businesses.

The display apparatus may output images externally using a backlight unit and a display panel. The display panel may be any of a liquid crystal display (LCD) device using a liquid crystal, a display panel using a light emitting diode (LED) capable of being independently irradiated, a display panel using an organic light emitting diode (OLED), a display panel using an active-matrix organic light emitting diode (AMOLED), etc.

### SUMMARY

Therefore, it is an aspect of the present disclosure to provide a display panel and a display apparatus which can simplify a production process using a liquid crystal capsule, do not generate optical variation caused by external pressure, and have various curvatures.

It is another aspect of the present disclosure to provide a display panel and a display apparatus which can prevent or minimize influence of liquid crystal molecules such as ultraviolet (UV) light, and can improve vulnerability of liquid crystal.

It is another aspect of the present disclosure to provide a display panel and a display apparatus which can prevent leakage of light from the display panel according to a difference in refractive index between materials contained in the display panel.

Additional aspects of the present disclosure will be set forth in part in the description which follows and, in part, will be obvious from the description, or may be learned by practice of the present disclosure.

Various exemplary embodiments of the present disclosure are directed to providing a display panel and a display apparatus that substantially obviate one or more problems due to limitations and disadvantages of the related art.

In accordance with one aspect of the present disclosure, a display panel includes: a liquid crystal capsule layer in which a plurality of liquid crystal capsules are distributed, each of the plurality of liquid crystal capsules including liquid crystal molecules; and an electrode unit disposed at one surface of the liquid crystal capsule layer and configured to form an electric field in the liquid crystal capsule layer, wherein a thickness of the liquid crystal capsule layer exceeds half a ratio of a wavelength of incident light to a birefringence value of the liquid crystal molecules.

Each of the plurality of liquid crystal capsules may include an outer wall layer to form an external appearance of the capsules and liquid crystal molecules distributed in the outer wall layer and aligned according to an electric field.

Each of the plurality of liquid crystal capsules may further include an interfacial active agent (or surfactant) to facilitate alignment of the liquid crystal molecules.

The liquid crystal capsule layer may include a polymer matrix in which the plurality of liquid crystal capsules is distributed.

A difference in refractive index between at least two of the outer wall layer, the liquid crystal molecules, and the polymer matrix may be equal to or less than 0.1.

The display panel may further comprise a color change unit configured to change a color of the incident light.

The electrode unit may be disposed between the liquid crystal capsule layer and the color change unit, or the color change unit may be disposed between the liquid crystal layer and the electrode unit.

The display panel may further comprise a substrate in which the electrode unit or the color change unit is seated.

The substrate may include a rigid substrate, a flexible substrate, or a rigid-flexible substrate.

The electrode unit may include a plurality of pixel electrodes arranged in a direction of the liquid crystal capsule layer, an insulation substrate in which the pixel electrodes are arranged at one surface thereof and a common electrode arranged at the other surface of the insulation substrate.

The display panel may further comprise a liquid-crystal-capsule-layer protection unit disposed at one surface of the liquid crystal capsule layer.

Each of the liquid crystal molecules may include a positive liquid crystal molecule.

If the electrode unit forms an electric field in the liquid crystal capsule layer, liquid crystal molecules of some liquid crystal capsules arranged in the direction of the electrode unit from among the plurality of liquid crystal capsules are aligned, and liquid crystal molecules of some other liquid crystal capsules from among the plurality of liquid crystal capsules are not aligned.

In accordance with another aspect of the present disclosure, a display apparatus may comprise a display panel configured to display images and a backlight unit configured to provide the display panel with light, wherein the display panel includes a liquid crystal capsule layer in which a plurality of liquid crystal capsules are distributed, each of the plurality of liquid crystal capsules including liquid crystal molecules and an electrode unit disposed at one surface of the liquid crystal capsule layer and configured to form an electric field in the liquid crystal capsule layer, wherein a thickness of the liquid crystal capsule layer exceeds half a ratio of a wavelength of incident light to a birefringence value of the liquid crystal molecules.

Each of the plurality of liquid crystal capsules may include an outer wall layer to form external appearance of the capsules and liquid crystal molecules distributed in the outer wall layer and aligned according to an electric field.

Each of the plurality of liquid crystal capsules may further include an interfacial active agent (or surfactant) to facilitate alignment of the liquid crystal molecules.

The liquid crystal capsule layer may include a polymer matrix in which the plurality of liquid crystal capsules is distributed.

The display panel may further include a substrate in which the electrode unit is seated, wherein the substrate includes a rigid substrate, a flexible substrate, or a rigid-flexible substrate.

The backlight unit may include at least one light source and a light guide plate in which light emitted from the at least one light source is incident upon a side surface of the light guide plate and is emitted in a direction of the display panel through one surface of the light guide plate.

The backlight unit may include at least one light source and a substrate in which the at least one light source is installed at one surface of a direction of the display panel.

### BRIEF DESCRIPTION OF THE DRAWINGS

These and/or other aspects of the present disclosure will become apparent and more readily appreciated from the following description of the exemplary embodiments, taken in conjunction with the accompanying drawings of which:

FIG. 1 is a block diagram illustrating a display apparatus according to an exemplary embodiment of the present disclosure.

FIG. 2 is a view illustrating an external appearance of the display apparatus according to an exemplary embodiment of the present disclosure.

FIG. 3 is an exploded perspective view illustrating the display apparatus according to an exemplary embodiment of the present disclosure.

FIG. 4 is a side cross-sectional view illustrating the display apparatus according to an exemplary embodiment of the present disclosure.

FIG. 5 is a side cross-sectional view illustrating a display panel according to an exemplary embodiment of the present disclosure.

FIG. 6A is a view illustrating an example of a liquid crystal capsule.

FIG. 6B is a conceptual diagram illustrating that an electric field is formed in the liquid crystal capsule.

FIG. 7A is a conceptual diagram illustrating an electric field formed in the liquid crystal capsule when power supply is applied to the display panel according to an exemplary embodiment of the present disclosure.

FIG. 7B is a conceptual diagram illustrating a path of light within the display panel when power supply is not applied to the display panel.

FIG. 7C is a conceptual diagram illustrating a path of light within the display panel when power is not supplied to the display panel.

FIG. 8 is a conceptual diagram illustrating the relationship among thickness of a liquid crystal capsule layer, a bi-refractive index value, and a wavelength of light.

FIG. 9 is a side cross-sectional view illustrating a display panel according to another exemplary embodiment of the present disclosure.

FIG. 10 is a conceptual diagram illustrating an electric field formed in the liquid crystal capsule when power is supplied to the display panel according to another exemplary embodiment of the present disclosure.

FIG. 11A is a conceptual diagram illustrating a situation in which external pressure is applied to a conventional display panel.

FIG. 11B is a conceptual diagram illustrating a situation in which external pressure is applied to a display panel including a liquid crystal capsule.

FIG. 12A is a view illustrating a curved state of a conventional display panel.

FIG. 12B is a view illustrating a curved state of a display panel including a liquid crystal capsule.

FIG. 13 is a conceptual diagram illustrating that leakage of light caused by a difference in refractive index occurs.

FIG. 14 is a conceptual diagram illustrating that no leakage of light occurs due to reduction of a difference in refractive index.

FIG. 15 is a side cross-sectional view illustrating an example of a display panel further including a UV absorbent according to an exemplary embodiment of the present disclosure.

FIG. 16 is a side cross-sectional view illustrating an example of a display panel further including a UV absorbent according to another exemplary embodiment of the present disclosure.

FIG. 17 is an exploded perspective view illustrating a display apparatus according to another exemplary embodiment of the present disclosure.

FIG. 18 is a side cross-sectional view illustrating a display apparatus according to another exemplary embodiment of the present disclosure.

### DETAILED DESCRIPTION

Reference will now be made in detail to the exemplary embodiments of the present disclosure, examples of which are illustrated in the accompanying drawings, wherein like reference numerals refer to like elements throughout.

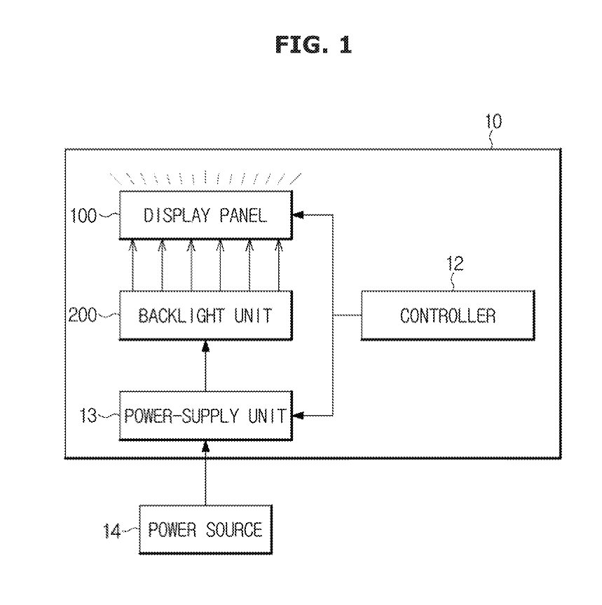

A display panel and a display apparatus according to exemplary embodiments of the present disclosure will hereinafter be described with reference to FIGS. 1 to 18.

FIG. 1 is a block diagram illustrating a display apparatus according to an exemplary embodiment of the present disclosure.

Referring to FIG. 1, a display apparatus 10 may include a controller 12, a power-supply unit 13, a display panel 100 through which incident light (L) passes or does not pass such that images are displayed thereon, and a backlight unit (BLU) 200 configured to emit the incident light (L) in the direction of the display panel 100.

The display panel 100 may generate images and display the images for user recognition. In accordance with one exemplary embodiment, the display panel 100 may receive light (L) from the backlight unit 200 through one surface thereof, and may change light on a sub-pixel basis. The display panel 100 may emit externally color-changed light or color-unchanged light through the other surface corresponding to the above surface having received the light (L). In this case, light (L) corresponding to respective sub-pixels is mixed such that the resultant light having a predetermined color may be emitted from one pixel of the display panel. The display panel may generate an image by combining light signals emitted from respective pixels, and may display the generated image for the user. In this case, the pixel may indicate a basic element for implementing functions of a display, and the sub-pixel may indicate a smaller region of each pixel.

The display panel 100 may adjust light emitted to the outside using a liquid crystal. In accordance with another exemplary embodiment, the display panel 100 may generate light using a light emitting diode (LED), a cold cathode fluorescent lamp (CCFL), an organic light emitting diode (OLED), or an active-matrix organic light emitting diode (AMOLED), and may display images using the generated light. A detailed description of the display panel 100 will be given later.

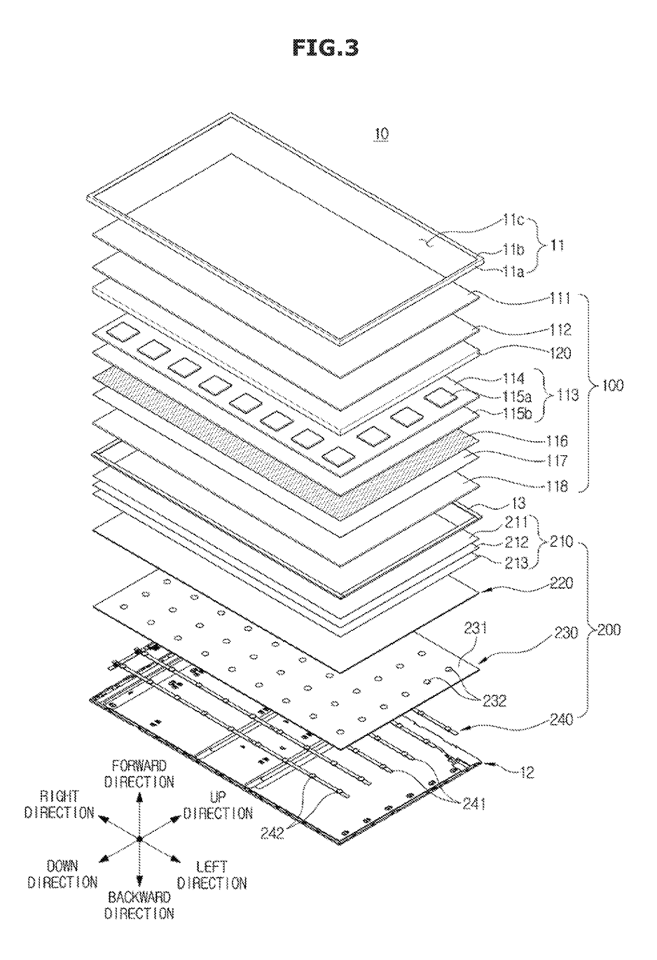

The backlight unit 200 may generate predetermined-colored light (L), may diffuse the predetermined-colored light (L), and may emit the diffused light (L) to the display panel 100, such that the light (L) can be incident upon all regions of one surface of the display panel 100. The backlight unit 200 may allow white-colored light or blue-colored light to be incident upon one surface of the display panel 100 according to an exemplary embodiment, such that the display panel 100 may perform color change using a color change unit (see 116, etc. shown in FIG. 3) provided in response to each color of the incident light, and may emit the resultant light having a changed color. For example, a color filter may be used as the color change unit. The backlight unit 200 may generate light (L) using the direct type or the edge type, and may emit the generated light (L) to the display panel 100 according to an exemplary embodiment. A detailed description of the backlight unit 200 will be described later.

The controller 12 may control various constituent elements of the display apparatus 10 such that the display panel 100 can perform a necessary operation. For example, the controller 12 may control the power-supply unit 13 or the display panel 100 such that the display apparatus 10 can display a predetermined still image or moving images thereon.

The controller 12 may include at least one processor, and the processor may be implemented using one semiconductor chip or at least two semiconductor chips and various constituent elements needed to operate a semiconductor chip. Meanwhile, a storage unit (not shown) configured to store various kinds of data so as to assist operations of the processor may also be used. The storage unit may be implemented using a semiconductor storage unit such as ROM/RAM or a Solid State Drive (SSD), or using a magnetic disk storage unit such as a Hard Disk Drive (HDD).

The power-supply unit 13 may provide a power-supply signal needed for image display to the display panel 100 or the backlight unit 200. The power-supply unit 13 may be connected to an external commercial power source 14. In this case, the power-supply unit 13 may rectify an AC power-supply signal received from the commercial power source 14 into a DC power-supply signal needed to operate the display apparatus 10, may change a received voltage to a necessary voltage level, or may remove noise generated from the DC power-supply signal. In accordance with one exemplary embodiment, the power-supply unit 13 may include a battery to store electricity therein. If necessary, the battery may also be implemented as a rechargeable battery.

For example, the display apparatus 10 may include various kinds of devices capable of displaying still images or moving images, for example, a television, various audio/video (A/V) systems, a home theater system, a desktop computer, a computer monitor, a camera, a moving image capturing device, an electronic display, and a mobile terminal. In this case, the mobile terminal may include a laptop, a cellular phone, a smartphone, a tablet PC, an E-book reader, a personal digital assistant (PDA), a navigation device, a portable gaming system, etc. In addition, the mobile terminal may display still images or moving images thereon, and various devices used at home or in industry may also be used as examples of the above-mentioned display apparatus.

For convenience of description and better understanding of the present disclosure, the following exemplary embodiments assume that the display apparatus 10 is implemented as a television. However, the scope and spirit of the display apparatus 10 are not limited thereto, and it should be noted that the display apparatus 10 can be implemented as any one of various kinds of devices as described above.

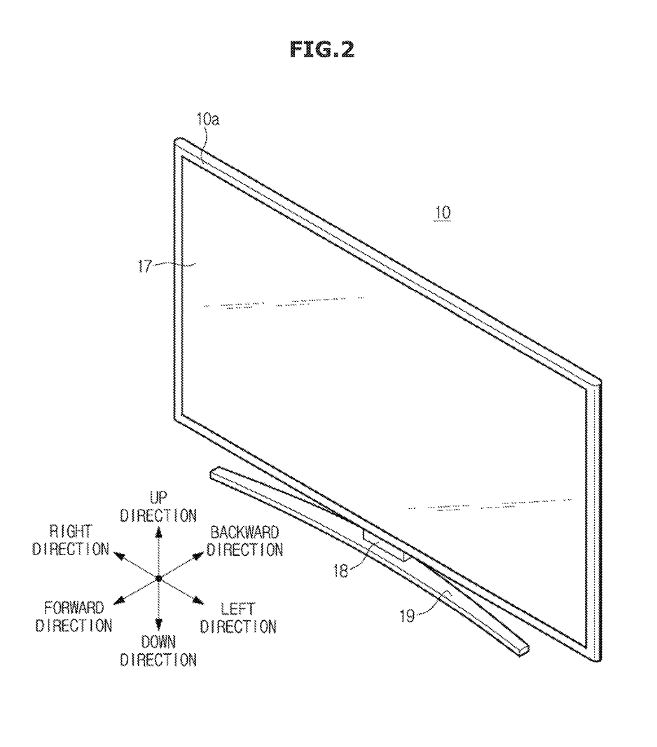

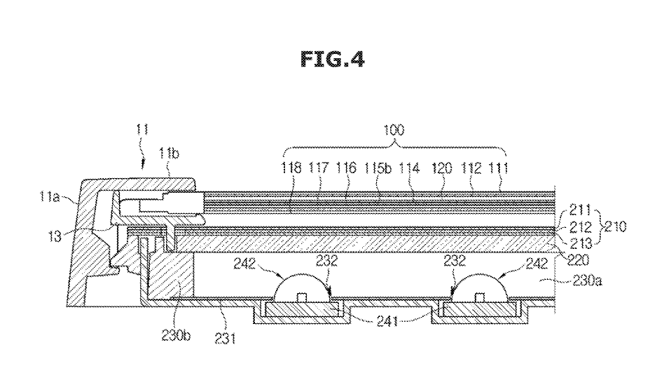

FIG. 2 is a view illustrating an external appearance of the display apparatus according to an exemplary embodiment of the present disclosure. FIG. 3 is an exploded perspective view illustrating the display apparatus according to an exemplary embodiment of the present disclosure. FIG. 4 is a side cross-sectional view illustrating the display apparatus according to an exemplary embodiment of the present disclosure.

For convenience of description, according to the above-mentioned display apparatus 10, it is assumed that a direction in which images are displayed will hereinafter be referred to as a forward direction, and the other direction opposite to the forward direction will hereinafter be referred to as a backward direction on the basis of the position of the display apparatus 10. In addition, a direction in which a support 18 or the like of the display apparatus 10 is formed will hereinafter be referred to as a lower direction, and the other direction opposite to the lower direction will hereinafter be referred to as an upper direction. In addition, from the standpoint of the upper direction, assuming that the forward direction is the 12 o'clock direction, the 3 o'clock direction is set to the right direction, and the 9 o'clock direction is set to the left direction. Therefore, as can be seen from FIG. 3, the upper direction (I) is assumed to be the forward direction of the display apparatus 10, and the lower direction (↓) is assumed to be the backward direction of the display apparatus 10. The above assumption may also be equally applied to the remaining drawings without departing from the scope or spirit of the present disclosure. The above-mentioned definition of four directions is disclosed only for illustrative purposes, and may also be defined in different ways according to system designers.

Referring to FIG. 2, the display apparatus 10 may include an external housing 10a for forming the external appearance thereof, an image display unit 17 for displaying images thereon, a support 18, and a leg 19.

The external housing 10a may form the external appearance of the display apparatus 10, and may include various constituent elements for allowing the display apparatus to display various images or to perform various functions. The external housing 10a may be integrated with the display apparatus 10, or may be comprised of a combination of a plurality of housings, for example, a front housing (11, etc.) and a rear housing 12 as necessary. An intermediate housing 13 may further be provided in the external housing 10a.

The image display unit 17 may be installed in the forward direction of the external housing 10a such that it can display various images. In more detail, the image display unit 17 may display at least one still image and/or at least one moving image. The image display unit 17 may be implemented using the display panel 100, and may also be implemented using additional components, such as a touchscreen panel, arranged in the forward direction of the display panel 100 according to exemplary embodiments.

The support 18 may support the external housing 10a, and at the same time may connect the external housing 10a to the leg 19. The support 18 may be formed in various shapes or be omitted according to selection of the designer. The support 18 may be detachably coupled to the external housing 10a according to one exemplary embodiment.

The leg 19 may be connected to the support 18, and may allow the display apparatus 10 to be stably disposed at various positions, for example, the bottom surface or the top surface of furniture. If necessary, the leg 19 may be connected to or disconnected from the support 18. The leg 19 may also be directly connected to the external housing 10a. The leg 19 may be omitted according to one exemplary embodiment.

Referring to FIGS. 3 and 4, the display apparatus 10 may include housings (11, 12) to form the external appearance thereof, a display panel 100 to form images thereon, and a backlight unit 200 to provide the display panel 100 with light.

In accordance with one exemplary embodiment, the housings (11, 12) may include a front housing 11 installed in a front-surface direction (forward direction), and a rear housing 12 installed in a back-surface direction (backward direction). In accordance with one exemplary embodiment, the front housing 11 may be integrated with the rear housing 12 in one body, and the front housing 11 may be detachably coupled to the rear housing 12.

The front housing 11 may be disposed at the head front-surface direction (foremost direction) of the display apparatus 10, and may form the external housing of some parts of the front surface and/or the side surface of the display apparatus 10. The front housing 11 may be coupled to the rear housing 12 so that various constituent elements of the display apparatus 10 may be embedded in the display apparatus 10. The front housing 11 may stably fix various constituent elements (e.g., the display panel 100) embedded in the display apparatus 10, and at the same time may protect the constituent elements from external impact.

The front housing 11 may be disposed at the foremost direction, and may include a fixing unit 11b to form a bezel and a side unit 11a extending from the end of the fixing unit 11b in the direction of the rear housing 12. The opening 11c may be formed at the front surface of the front housing 11. The side unit 11a may be coupled to the rear housing 12, and may interconnect the front housing 11 and the rear housing 12. The side unit 11a may allow various constituent elements to be fixed at the inside of the display apparatus 10, and may protect various constituent elements embedded in the display apparatus 10 from lateral impact. The fixing unit 11b may protrude in the direction of the opening 11c, and may fix various constituent elements such as the display panel 100, such that secession of associated components may be prevented or the associated components may also be prevented from being partially exposed. The opening 11c may allow the display panel 100 to be exposed, and may display images formed by the display panel 100, such that the user can view the displayed images. In more detail, the opening 11c may allow images formed by light, having passed through the first polarization filter 111, to be displayed.

The rear housing 12 may be disposed at the rearmost direction of the display apparatus 10, and may form the external appearance of some parts of a back surface and/or a side surface of the display apparatus 10. The rear housing 12 may be connected to the front housing 11 in a manner that various components of the display apparatus 10 can be embedded in the display apparatus 10. A reflective plate 230 and a light emitting unit 240 of the backlight unit 200 may be installed at the inner surface of the rear housing 12. The display panel 100 will hereinafter be described with reference to the attached drawings.

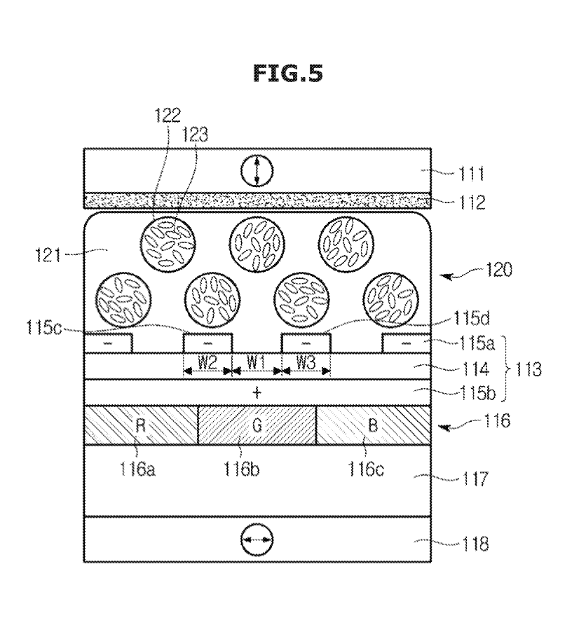

FIG. 5 is a side cross-sectional view illustrating a display panel according to an exemplary embodiment of the present disclosure.

Referring to FIGS. 3 to 5, the display panel 100 of the display apparatus 10 may include a first polarization unit 111, a protection unit 112 for protecting a liquid crystal capsule layer, a liquid crystal capsule layer 120, an electrode layer 113, a color change unit 116, a substrate 117, and a second polarization unit 118. Some parts from among the above-mentioned constituent elements may be omitted or may be replaced with other elements according to exemplary embodiments.

The first polarization unit 111 may polarize incident light and emit the polarized light. The first polarization unit 111 may be disposed at the head front-surface direction (foremost direction) of the display panel 100. One surface of the first polarization unit 111 may be exposed through the opening 11c, and the other surface located opposite to the one surface may contact the liquid-crystal-capsule-layer protection unit 112 or the liquid crystal capsule layer 120. The first polarization unit 111 may be implemented in the form of a film.

The light having passed through either the protection unit 112 or the liquid crystal capsule layer 120 may be incident upon the other surface of the first polarization unit 111. The light having passed through the protection unit 112 or the liquid crystal capsule layer 120 may pass through the second polarization unit 118 to be described later, and may be polarized in the vertical or horizontal direction. As described above, the light polarized in the vertical or horizontal direction through the second polarization unit 118 may pass through the first polarization unit 111 according to the direction of vibration, and may be emitted to the outside or may be interrupted by the first polarization unit 111.

The first polarization unit 111 may include a vertical polarization filter in which a polarization axis is vertical or a horizontal polarization filter in which a polarization axis is horizontal. The polarization axis of the first polarization unit 111 may be different from the polarization axis of the second polarization unit 118. In more detail, the polarization axis of the first polarization unit 111 and the polarization axis of the second polarization unit 118 may be orthogonal to each other. Therefore, assuming that the second polarization unit 118 is the vertical polarization filter, the first polarization unit 111 may be the horizontal polarization filter. Assuming that the second polarization unit 118 is the horizontal polarization filter, the first polarization unit 111 may be the vertical polarization filter.

One surface of the forward direction of the liquid crystal capsule layer 120 may be arranged to face the first polarization unit 111. A plurality of liquid crystal capsules 122 may be contained in the liquid crystal capsule layer 120. If incident light is received from the rear direction of the liquid crystal capsule layer 120, double refraction (bi-refraction) of the incident light may arise according to an electric field applied to the liquid crystal capsules 122.

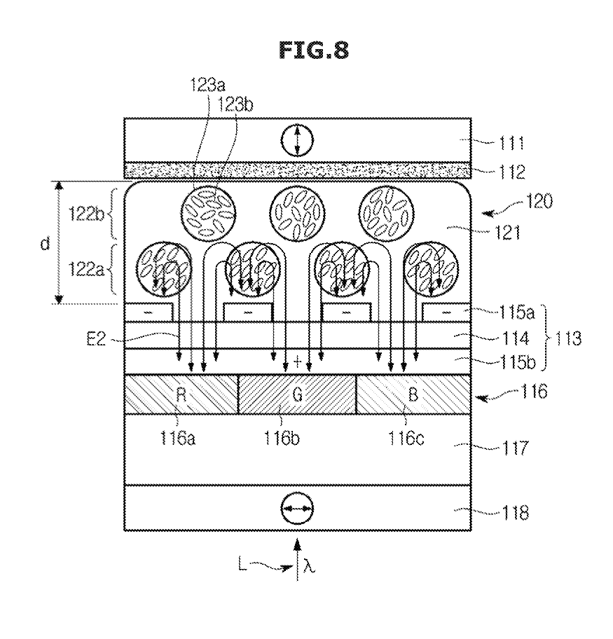

In accordance with one exemplary embodiment, the liquid crystal capsule layer 12 may be deposited over one surface of at least one of the electrode layer 113 and the substrate 117. In this case, the liquid crystal capsule layer 12 may be deposited to a predetermined thickness (e.g., ‘d’ shown in FIG. 8) over one surface of at least one of the electrode layer 113 and the substrate 117.

In accordance with one exemplary embodiment, the liquid crystal capsule layer 120 may include a polymer matrix 121, and the plurality of liquid crystal capsules 122 distributed in the polymer matrix 121.

The polymer matrix 121 may be an organism formed of a polymer having a relatively high molecular weight. The polymer matrix 121 may be formed of a transparent material. For example, the polymer matrix 121 may be formed of synthetic resins. For example, the polymer matrix 121 may be formed of epoxy, polyurethane, methacrylic acid, dicyclopentadiene epoxy, polydicyclopentadiene, polyimide, or the like. The plurality of liquid crystal capsules 122 may be distributed in the polymer matrix 121 at random.

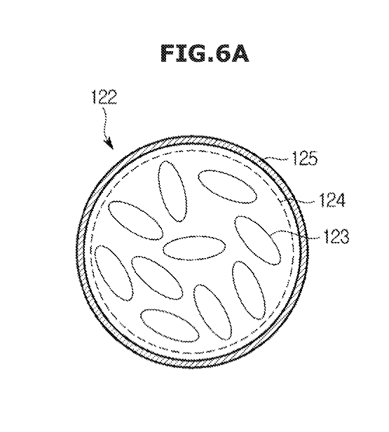

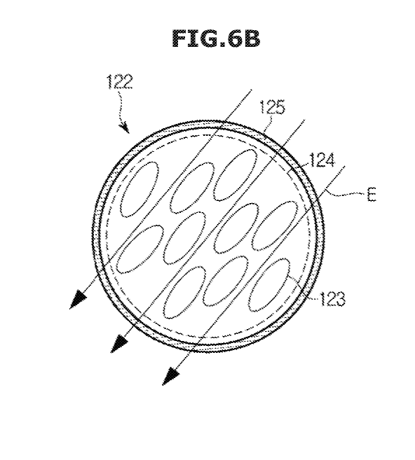

FIG. 6A is a view illustrating an example of a liquid crystal capsule. FIG. 6B is a conceptual diagram illustrating that an electric field is formed in the liquid crystal capsule.

Referring to FIG. 6A, each of the liquid crystal capsules 122 may be a capsule form of the liquid crystal molecules 123, and may include liquid crystal molecules therein. The liquid crystal capsule 122 may have a nano-scale structure, for example, may have a circular or oval shape having a diameter of about 10 nm to 300 nm.

The liquid crystal capsules 122 may be manufactured by interfacial polymerization, complex coacervation, membrane emulsification, or in-situ polymerization.

In more detail, the liquid crystal capsule 122 may include liquid crystal molecules 123, a surfactant (interfacial active agent) 124, and a capsule outer wall layer 125.

The liquid crystal molecules 123 may be distributed in the capsule outer wall layer 125 of the liquid crystal capsule 122. As can be seen from FIG. 6A, if additional electric field (E) is not formed in the liquid crystal capsule 122, the liquid crystal molecules 123 may be arranged in the capsule outer wall layer 125 at random. As can be seen from FIG. 6B, if additional electric field (E) is formed in the liquid crystal capsule 122, the liquid crystal molecules 124 may be arranged in the direction of the formed electric field (E).

The liquid crystal molecules 123 may include a positively charged liquid crystal molecule or a negatively charged liquid crystal molecule. The positively charged liquid crystal molecule may be a liquid crystal molecule arranged horizontal to the received electric field (E) direction, and the negatively charged liquid crystal molecule may be a liquid crystal molecule arranged perpendicular to the received electric field (E) direction. For example, assuming that the liquid crystal molecules 123 are positively charged liquid crystal molecules and the electric field (E) is formed in a downward direction (i.e., from the UP direction to the DOWN direction) as shown in FIG. 6B, the liquid crystal molecules 123 may be arranged (or aligned) in the electric field (E) direction.

The surfactant 124 may be distributed in the capsule outer wall layer 125 of the liquid crystal capsule 122. The surfactant may change interactive force between the capsule outer wall layer 125 and the liquid crystal molecules 123, such that the liquid crystal molecules 124 may relatively freely move or pivot within the capsule outer wall layer 125. Therefore, the liquid crystal molecules 123 contained in the liquid crystal capsule 122 may be relatively easily aligned. The surfactant 124 may be implanted as an additive agent in the liquid crystal capsule 122. If the surfactant 124 is implanted in the liquid crystal capsule 122, the surfactant 124 may be mainly distributed in the inner surface of the capsule outer wall layer 125 as shown in FIGS. 6A and 6B, such that interactive force between the capsule outer wall layer 125 and the liquid crystal molecule 123 may be changed. In accordance with one exemplary embodiment, the surfactant 124 may also be omitted as necessary.

The capsule outer wall layer 125 may be formed to include liquid crystal molecules 123 therein. If necessary, the capsule outer wall layer 125 may further include the surfactant 124 therein. The capsule outer wall layer 125 may protect the plurality of liquid crystal molecules 123 at the inside thereof, and several liquid crystal molecules 123 are separated from the polymer matrix 121 such that several liquid crystal molecules 123 are prevented from being distributed in the liquid crystal capsule layer 120 according to deformation of the polymer matrix 121 caused by external pressure or the like. The capsule outer wall layer 125 may be manufactured using a chemical compound (e.g., a polymer) having a high molecular weight.

In accordance with one exemplary embodiment, dielectric constant (permittivity) (Δ∈) of the liquid crystal molecules 123 may be set to the value of 10 or greater. In addition, assuming that the liquid crystal molecules 123 are aligned as shown in FIG. 6B, a birefringence value (Δn) of the liquid crystal molecules 123 may be set to 0.1 or greater. This bi-refraction value (Δn) may indicate the optical anisotropic size.

In accordance with one exemplary embodiment, the liquid-crystal-capsule-layer protection unit 112 may be disposed between the first polarization unit 111 and the liquid crystal capsule layer 120. The liquid-crystal-capsule-layer protection unit 112 may protect the liquid crystal capsule layer 120. In more detail, assuming that the liquid crystal capsule layer 120 contacts external air, lifespan of a material can be shortened due to characteristics of organic materials. As a result, in order to prevent reduction in lifespan, the liquid-crystal-capsule-layer protection unit 112 may be installed at one surface disposed in the forward direction thereof, such that contact between outside air and the liquid-crystal-capsule-layer protection unit 112 can be prevented. In addition, the original state or shape of the liquid crystal capsule layer 120 can also be maintained. For example, the original state of a coating layer formed at the outer surface of the liquid crystal capsule layer 120 may also be maintained. The liquid-crystal-capsule-layer protection unit 112 may be implemented using a predetermined protective film. The liquid-crystal-capsule-layer protection unit 112 may also be omitted as necessary.

If the liquid crystal capsule layer 120 is provided as described above, the liquid crystal capsule layer 120 may be present independently, such that an additional substrate is no longer required in the forward direction (i.e., the direction of the first polarization unit 111). As a result, the production process becomes simplified, and a curved display panel or flexible display panel is implemented.

The electrode layer 113 configured to form the electric field in the liquid crystal capsule layer 120 may be formed at one surface of the backward direction (back-surface direction) of the liquid crystal capsule layer 120. In accordance with one exemplary embodiment, electrodes (115a, 115b) may be structured in the electrode layer 113 according to the Fringe-Field Switching (FFS) scheme. The FFS-based electrode arrangement structure may include a PLS-based electrode arrangement structure or ADS-based electrode arrangement structure.

In accordance with one exemplary embodiment, the electrode layer 113 may include an insulation substrate 114, a pixel electrode 115a, and a common electrode 115b as shown in FIG. 5.

In the insulation substrate 114, the pixel electrode 113 may be disposed at one surface of the direction of the liquid crystal capsule layer 120, and the common electrode 115b may be disposed at one surface of the backward direction of the liquid crystal capsule layer 120. In this case, since the liquid crystal capsule layer 120 is attached to or deposited on one surface of the insulation substrate 114, the liquid crystal capsule layer 120 may be formed over the insulation substrate 114. The insulation substrate 114 may prevent a current from directly flowing into the space between the pixel electrode 113 and the common electrode 115b. The insulation substrate 114 may be formed of a transparent material in a manner that light having passed through the second polarization unit 118 in the backward direction can pass through the insulation substrate 114. For example, the insulation substrate 114 may be implemented using a synthetic resin such as acryl, or using glass. In accordance with one exemplary embodiment, the insulation substrate 114 may include a rigid substrate, a flexible substrate, or a rigid-flexible substrate according to exemplary embodiments. The rigid-flexible substrate may be a multilayer substrate formed of a laminated structure of the flexible substrate and the rigid substrate.

The pixel electrode 115a may be arranged to face the common electrode 115b on the basis of the insulation substrate 114. The pixel electrode 115a and the common electrode 115b may provide a current to the liquid crystal capsule layer 120. One surface of the forward direction (front-surface direction) may contact or approach the liquid crystal capsule layer 120. The pixel electrode 115a may be a cathode (−) or an anode (+). The pixel electrode 115a may be implemented using a thin film transistor (TFT) according to exemplary embodiments. The pixel electrode 115a may be connected to the external power-supply unit, and may thus receive the power-supply signal from the external power-supply unit.

A plurality of pixel electrodes (115a, 115c, 115d) may be disposed in the insulation substrate 114. In accordance with one exemplary embodiment, the pixel electrodes (115a, 115c, 115d) may be arranged in a predetermined pattern and disposed over the insulation substrate 114. The arrangement pattern of the pixel electrodes (115a, 115c, 115d) may correspond to respective pixels of the display panel 100. The arrangement pattern of the pixel electrodes (115a, 115c, 115d) may be determined in various ways according to selection of the designer.

The pixel electrodes (115c, 115d) may be separated from each other by a predetermined distance (w1). In this case, each of the widths (w2, w3) of the respective pixel electrodes (115c, 115d) may be larger than a distance (w1) between the pixel electrodes (115c, 115d). In this case, the widths (w2, w3) of the pixel electrodes (115c, 115d) may indicate the distance from the left end to the right end of the pixel electrodes (115c, 115d) or the distance between the upper end to the lower end of the pixel electrodes (115c, 115d). In other words, the width of each of the pixel electrodes (115c, 115d) may be longer than the distance between the pixel electrodes (115c, 115d).

The common electrode 115b may provide a current to the liquid crystal capsule layer 120 so that liquid crystal molecules 123 contained in the liquid crystal capsule 122 can be aligned in the liquid crystal capsule layer 120. The common electrode 115b may have the opposite polarity to that of the pixel electrode 115a. For example, if the pixel electrode 115a is the cathode, the common electrode 115b may be used as the anode. If the pixel electrode 115a is the anode, the common electrode 115b may be used as the cathode. One surface of the forward direction of the common electrode 115b may be formed to contact one surface of the backward direction of the insulation substrate 114. In accordance with one exemplary embodiment, one surface of the backward direction of the common electrode 115b may contact or neighbor the color change unit 116.

If anodes of the display panel 100 are powered on, an electric field formed in the liquid crystal capsule layer 120 and the light path associated with the electric field will be given.

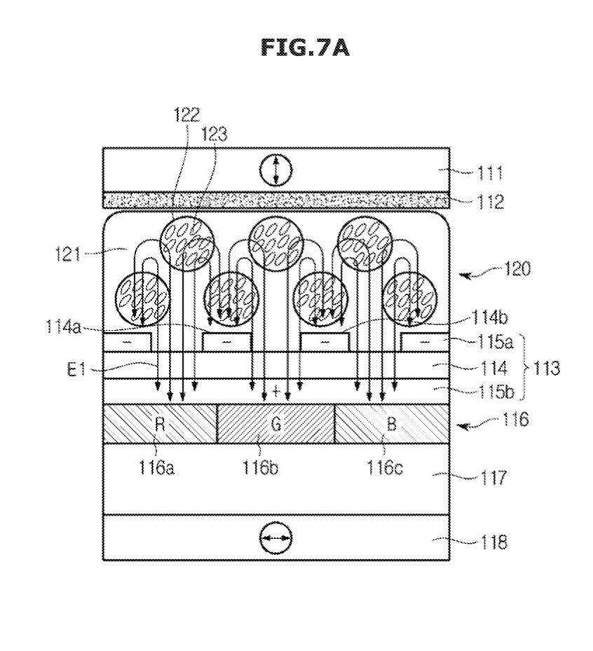

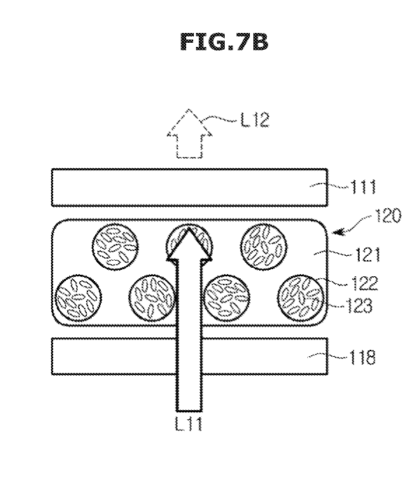

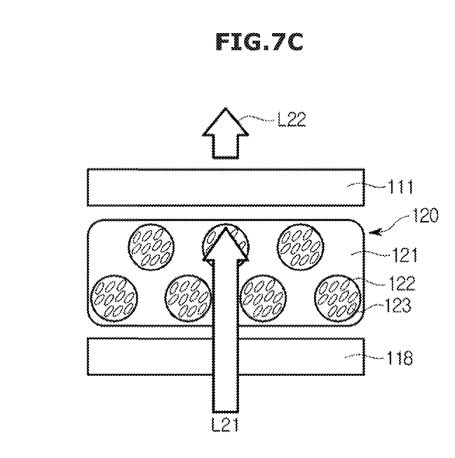

FIG. 7A is a conceptual diagram illustrating an electric field formed in the liquid crystal capsule when power supply is applied to the display panel according to an exemplary embodiment of the present disclosure. FIG. 7B is a conceptual diagram illustrating a path of light within the display panel when power is not supplied to the display panel. FIG. 7C is a conceptual diagram illustrating a path of light within the display panel when power is not supplied to the display panel.

Assuming that the pixel electrodes (114a, 114b) and the common electrode 115b of the electrode layer 113 are powered on, the fringe field (E1) may be formed between the communication electrode 115b and the pixel electrodes (114a, 114b), as shown in FIG. 7A. The fringe field (E1) may be aligned from the outside to the inside of the liquid crystal capsule layer 120 at one surface of the liquid crystal capsule layer 120, and may change the direction of the fringe field (E1) in the liquid crystal capsule layer 120. Thereafter, the fringe field (E1) may be aligned from the inside to the outside of the liquid crystal capsule layer 120 at the same surface as in the liquid crystal capsule layer 120. If the electric field is formed in the liquid crystal capsule layer 120 by the above-mentioned fringe field (E1), an electric field of the predetermined direction (e.g., an electric field of the horizontal direction) may be applied to the liquid crystal molecules 123 contained in the liquid crystal capsule 122. Assuming that the electric field of the predetermined direction is applied to the liquid crystal molecules 123 as described above, the liquid crystal molecules 123 may be aligned in a predetermined direction as described above, light incident upon the other surface of the backward direction of the liquid crystal capsule layer 120 may be bi-refracted according to arrangement of the liquid crystal molecules 123 contained in the liquid crystal capsule layer 120, such that the bi-refracted light may be emitted through one surface of the forward direction of the liquid crystal capsule layer 120.

Referring to FIG. 7B, assuming that the electric field (E1) is not formed in the liquid crystal capsule layer 120, the liquid crystal molecules 123 contained in the liquid crystal capsule 122 may be arranged at random. In this case, since bi-refraction does not occur in the liquid crystal capsule layer 120, light (L11) having passed through the second polarization unit 118 and the liquid crystal capsule 122 cannot pass through the first polarization unit 111 (as denoted by L12). Therefore, light may not be emitted through the first polarization unit 111, and the display panel 100 may display black.

Referring to FIG. 7C, assuming that the electric field (E1) is formed in the liquid crystal capsule layer 120, the liquid crystal molecules 123 may be aligned in the liquid crystal capsule 122. In this case, the light incident upon the liquid crystal capsule layer 120 after having passed through the second polarization unit 118 may be bi-refracted after passing through the liquid crystal capsule 122, such that the light (L21) having passed through the second polarization unit 118 and the liquid crystal capsule layer 120 may be emitted outside through the first polarization unit 111 (as denoted by L22). Therefore, if the electric field (E1) is formed in the liquid crystal capsule layer 120, the display panel 100 may emit light based on a predetermined color (for example, white-based light, blue-based light, green-based light, or red-based light) to the outside, and may represent a predetermined still image composed of various colors or moving images composed of various colors.

FIG. 8 is a conceptual diagram illustrating the relationship among a thickness of a liquid crystal capsule layer, a birefringence value, and a wavelength of light.

Referring to FIG. 8, the liquid crystal capsule layer 120 may have a predetermined thickness (d). In this case, the thickness (d) may indicate the distance between one surface and the other surface of the liquid crystal capsule layer 120. For example, one surface of the liquid crystal capsule layer 120 may contact either the first polarization unit 111 or the liquid-crystal-capsule-layer protection unit 112, and the other surface thereof may contact the electrode layer 113. In this case, although the thickness (d) of the liquid crystal capsule layer 120 may be exemplarily set to any value in the range from 10 μm to 100 nm, the scope or spirit of the present disclosure is not limited thereto, and the thickness (d) of the liquid crystal capsule layer 120 may be determined in various ways according to selection of the designer.

In accordance with one exemplary embodiment, the thickness (d) of the liquid crystal capsule layer 120 may be determined to exceed half a ratio of a wavelength (λ) of the incident light (L) to a birefringence value (Δn) of the liquid crystal molecules 123 of the liquid crystal capsules 122 distributed in the liquid crystal capsule layer 120.

In other words, the relationship among the thickness (d) of the liquid crystal capsule layer 120, the birefringence value (Δn), and wavelength (λ) of light (L) may be represented by the following equation 1.

Δn·d>0.5λ [Equation 1]

In Equation 1, Δn may denote a birefringence value of the liquid crystal molecules 123, “d” may denote a thickness of the liquid crystal capsule layer 120, and λ may denote wavelength of light (L). As described above, Δn may be set to 0.1 or higher. Differently from Equation 1, assuming that the product (i.e., the left-hand side of Equation 1) of the birefringence value (Δn) and the thickness (d) is equal to or less than 0.5λ (i.e., the right-hand side of Equation 1), no light may be emitted from the first polarization unit 111. Alternatively, assuming that light is emitted from the first polarization unit 111, brightness of the emitted light is reduced. Although the electric field (E1) is formed in the liquid crystal capsule layer 120 as shown in FIG. 7A, not all the liquid crystal capsules 122 may be affected by the electric field (E1) formed by the electrode layer 113, such that the brightness of the emitted light is reduced.

In more detail, as shown in FIG. 8, assuming that a power-supply signal is applied to the electrode layer 113, the electric field (e.g., the fringe field E2) may be formed only in some parts of the liquid crystal capsule layer 120 due to intensity of a voltage or the like. Therefore, the electric field E2 may be formed only in some liquid crystal capsules 122a adjacent to the direction of the electrode layer 113 from among the liquid crystal capsules 122 contained in the liquid crystal capsule layer 120. However, the above-mentioned electric field E2 may not be formed in some liquid crystal capsules 122b located in the direction of the first polarization unit 111 from among the liquid crystal capsules 122 contained in the liquid crystal capsule layer 120. That is, the electric field E2 may not be formed in some liquid crystal capsules 122b spaced apart from the electrode layer 113 by a predetermined distance. Therefore, the liquid crystal molecules 123a contained in some liquid crystal capsules 122a (having the electric field E2) adjacent to the direction of the electrode layer 113 contained in the liquid crystal capsules 122a are aligned according to the formed electric field E2. However, the liquid crystal molecules 123b contained in some liquid crystal capsules 122b (in which the electric field E2 is not formed) spaced apart from the electrode layer 113 may not be aligned even though the power-supply signal is applied to the electrode layer 113, or may have an insufficient alignment state when the power-supply signal is applied to the electrode layer 113. As described above, the liquid crystal molecules 123a contained in some liquid crystal capsules 122a are aligned whereas the liquid crystal molecules 123b contained in some other liquid crystal molecules 123b may not be aligned or may have a relatively insufficient alignment degree, such that it is impossible for the first polarization unit 111 to emit a sufficient amount of light. Therefore, brightness of the light emitted from the display panel 100 may be decreased.

As can be seen from Equation 1, assuming that the thickness (d) of the liquid crystal capsule layer 120 is determined to exceed the half the ratio of a wavelength (λ) of the incident light (L) to a birefringence value (Δn) of the liquid crystal molecules 123 of the liquid crystal capsules 122 distributed in the liquid crystal capsule layer 120, brightness of light emitted from the display panel 100 is not decreased although the electric field E2 is formed only in some liquid crystal capsules 122a. In more detail, assuming that the thickness (d) of the liquid crystal capsule layer 120 exceeds the half the ratio of a wavelength (λ) of the incident light (L) to the bi-refraction value (Δn) of the liquid crystal molecules 123, a polarization axis of the light L incident upon the liquid crystal capsule layer 120 is sufficiently changed according to the polarization axis of the first polarization unit 111, such that light having passed through the liquid crystal capsule layer 120 may be appropriately emitted to the first polarization unit 111. Therefore, the still image or moving images to be displayed on the display panel 100 may be displayed with sufficient brightness, resulting in improvement of image visibility.

Referring to FIGS. 5, 7A, and 8, according to one exemplary embodiment, the color change unit 116 may be provided at one surface of the backward direction of the electrode layer 113. In more detail, the color change unit 116 may be provided at one surface of the backward direction of the common electrode 115b.

The color change unit 116 may change incident light having a predetermined color to light having another color, or may not change the incident light and may output the incident light without change. For example, the color change unit 116 may change white-based light incident upon one surface of the backward direction to green-based light or red-based light, and may then emit the resultant light to the other surface of the forward direction, such that the resultant light may be transferred in the direction of the liquid crystal capsule layer 120.

The color change unit 116 may be located between the electrode layer 113 and the substrate 117. Therefore, one surface of the forward direction of the color change unit 116 may contact or neighbor the electrode layer 113, for example, one surface of the backward direction of the common electrode 115b, and the other surface of the backward direction may contact or neighbor one surface of the forward direction of the substrate 117. The color change unit 116 may be applied, attached or deposited over one surface of the forward direction of the substrate 117.

In accordance with one exemplary embodiment, the color change unit 116 may include a red-light conversion element 116a, a green-light conversion element 116b, and a blue-light conversion element 116c. In more detail, if the white-based light is incident upon the color change unit 116, the red-light conversion element 116a may convert white-based light into red-based light, the green-light conversion element 116b may convert the white-based light into green-based light, and the blue-light conversion element 116c may convert the white-based light into blue-based light. At least one of the red-based light emitted from the red-light conversion element 116a, the green-based light emitted from the green-light conversion element 116b, and the blue-based light emitted from the blue-light conversion element 116c passes through the liquid crystal capsule layer 120 and the first polarization unit 111, and is emitted to the outside. At least one of the emitted red-based light, the emitted green-based light, and the emitted blue-based light may be mixed with each other or may not be mixed with each other, and the resultant light is emitted to the outside, such that the display panel may express a predetermined color through a specific pixel.

The red-light conversion element 116a, the green-light conversion element 116b, and the blue-light conversion element 116c may be in contact with one another, or may be spaced apart from one another by about a predetermined distance. If the red-light conversion element 116a, the green-light conversion element 116b, and the blue-light conversion element 116c are spaced apart from one another, a barrier (e.g., a light barrier) may be disposed between the conversion elements (116a, 116b, 116c).

The red-light conversion element 116a, the green-light conversion element 116b, and the blue-light conversion element 116c may be arranged over the substrate 117 according to a predetermined pattern, and each arrangement pattern may correspond to a sub-pixel of the display panel 100. The red-light conversion element 116a, the green-light conversion element 116b, and the blue-light conversion element 116c may have the same size or may have different sizes. In addition, the number of the red-light conversion elements 116a, the number of green-light conversion elements 116b, and the number of blue-light conversion elements 116c arranged over the same substrate 117 may differ from one another. For example, the number of red-light conversion elements 116a or the number of green-light conversion elements 116b may be higher than the number of blue-light conversion elements 116c.

In accordance with another exemplary embodiment, the color change unit 116 may include a red-light conversion element 116a, a green-light conversion element 116b, and a transmission element (not shown). In more detail, if blue-based light is incident upon the color change unit 116 through the second polarization unit 118, the red-light conversion element 116a may convert blue-based light into red-based light, the green-light conversion element 116b may convert the blue-based light into green-based light, and the transmission element may transmit the blue-based light.

The red-light conversion element 116a may be implemented using the red color filter, the green-light conversion element 116b may be implemented using the green color filter, and the blue-light conversion element 116c may be implemented using the blue color filter. In accordance with one exemplary embodiment, at least one of the red-light conversion element 116a, the green-light conversion element 116b, and the blue-light conversion element 116c may also be implemented using a quantum dot so as to perform conversion of light color.

Light converted in and emitted from the color change unit 116 may be incident upon the liquid crystal capsule layer 120 through the electrode layer 113.

The substrate 117 may be provided in a manner that respective color change elements (116a, 116b, 116c) of the color change unit 116 are seated on one surface of the forward direction. The second polarization unit 118 may be mounted to one surface of the backward direction of the substrate 117. The substrate 117 may be a printed circuit board (PCB). In accordance with one exemplary embodiment, the substrate 117 may be a rigid substrate, a flexible substrate, or a rigid-flexible substrate. If the substrate 117 is implemented as the flexible substrate, the display panel 100 may be curved in a predetermined direction.

The second polarization unit 118 may polarize light incident from the backlight unit 200. From among incident light signals from the second polarization unit 118, only the light signal vibrating in the same direction as the polarization axis of the second polarization unit 118 may be incident upon the substrate 117. One surface of the second polarization unit 118 may contact or neighbor one surface of the backward direction of the substrate 117. In accordance with one exemplary embodiment, the second polarization unit 118 may include a vertical polarization filter or a horizontal polarization filter. As described above, the polarization axis of the second polarization unit 118 may be different from the polarization axis of the first polarization unit 111. In more detail, the polarization axis of the second polarization unit 118 may be orthogonal to the polarization axis of the first polarization unit 111. Therefore, if the first polarization unit 111 is implemented as the vertical polarization filter, the second polarization unit 119 may be the horizontal polarization filter. If the first polarization unit 111 is implemented as the horizontal polarization filter, the second polarization unit 118 may be the vertical polarization filter.

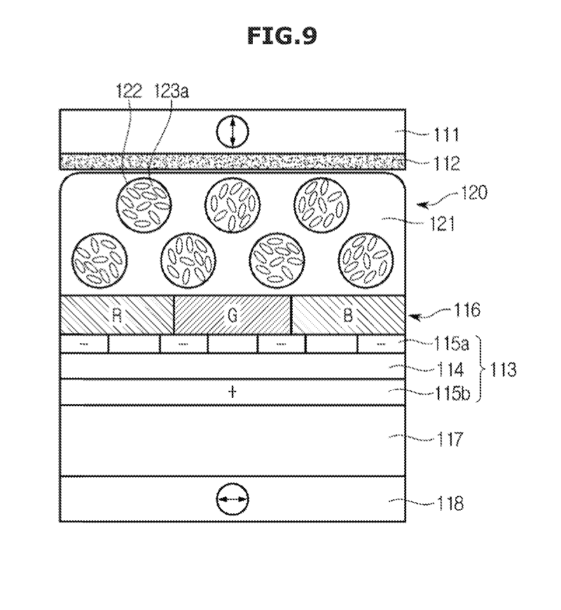

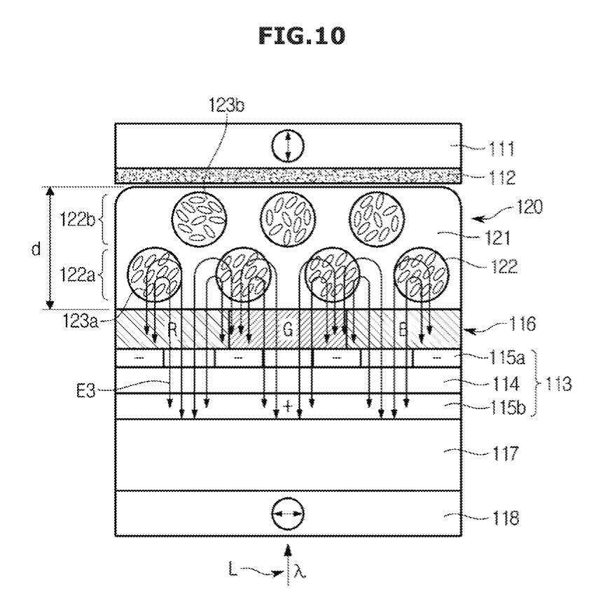

FIG. 9 is a side cross-sectional view illustrating a display panel according to another exemplary embodiment of the present disclosure. FIG. 10 is a conceptual diagram illustrating an electric field formed in the liquid crystal capsule when power supply is applied to the display panel according to another exemplary embodiment of the present disclosure.

Referring to FIGS. 9 and 10, the display panel 100 may include a first polarization unit 111, a liquid-crystal-capsule-layer protection unit 112, a liquid crystal capsule layer 120, an electrode layer 113, a color change unit 116, a substrate 117, and a second polarization unit 118. In this case, the color change unit 116 may also be disposed between the liquid crystal capsule layer 120 and the electrode layer 113. In accordance with the exemplary embodiments, some parts of the above-mentioned constituent elements of the display panel 100 may be omitted or be replaced with other components

The first polarization unit 111, the liquid-crystal-capsule-layer protection unit 112, the liquid crystal capsule layer 120, and the second polarization unit 118 have already been given in FIGS. 3 to 8, and as such a detailed description thereof will herein be omitted for convenience of description.

The color change unit 116 according to one exemplary embodiment may be designed in a manner that one surface arranged in the forward direction of the color change unit 116 may contact or neighbor one surface arranged in the backward direction of the liquid crystal capsule layer 120. In more detail, one surface of the forward direction of each of the red-light conversion element 116a, the green-light conversion element 116b, and the blue-light conversion element 116c contained in the color change unit 116 may contact or neighbor one surface of the backward direction of the liquid crystal capsule layer 120. In addition, the other surface arranged in the backward direction of the color change unit 116 may contact or neighbor the electrode layer 113. In other words, one surface of the backward direction of each of the red-light conversion element 116a, the green-light conversion element 116b, and the blue-light conversion element 116c may contact or neighbor the pixel electrode 115a or the substrate 114 of the electrode layer 113. That is, the color change unit 116 may be disposed between the electrode layer 113 and the liquid crystal capsule layer 120.

One surface of the forward direction of the electrode layer 113 may contact or neighbor the color change unit 116, and one surface of the backward direction may contact or neighbor one surface of the forward direction of the substrate 117. As describe above, the electrode layer 113 may include the substrate 114, the pixel electrode 115a, and the common electrode 115b, at least one of the substrate 114 and the pixel electrode 115a may contact the color change unit 116, and the common electrode 115b may contact or neighbor the substrate 117. In this case, the substrate 117 may be designed in a manner that the common electrode 115b is seated thereon. The electrode layer 113 may form the electric field (e.g., the fringe field E3) according to the power-supply signal applied to the pixel electrode 115a and the common electrode 115b, as shown in FIG. 10. The formed electric field E3 may be formed not only in the liquid crystal capsule layer 120 but also in the color change unit 116.

If the liquid crystal capsule layer 120, the electrode 113, the color change unit 116, and the substrate 117 are arranged as described above, the electrode layer 113 may be spaced apart from the liquid crystal capsule layer 120 on the basis of the color change unit 116 interposed therebetween. Accordingly, the electric field (e.g., the fringe field E3) formed by the electrode layer 113 may be formed only in some parts of the liquid crystal capsule layer 120 as shown in FIG. 10. As a result, the electric field E3 may be formed only in some liquid crystal capsules 122a adjacent to the direction of the electrode layer 113 from among the liquid crystal capsules 122 contained in the liquid crystal capsule layer 120. If necessary, the electric field E3 may not be formed in some liquid crystal capsules 122b spaced apart from the electrode layer 113 by a predetermined distance. Consequently, the liquid crystal molecules 123a of some liquid crystal capsules 122a may be aligned, and the liquid crystal molecules 123b of some other liquid crystal capsules 122b may not be aligned, resulting in reduction of brightness emitted from the display panel 100.

In this case, as can be seen from Equation 1, assuming that the thickness (d) of the liquid crystal capsule layer 120 exceeds half a ratio of a wavelength (λ) of the incident light (L) to a birefringence value (Δn) of the liquid crystal molecules 123, although the electric field E3 is formed only in some liquid crystal capsules 122a, reduction of brightness of the light emitted from the display panel 100 is prevented.

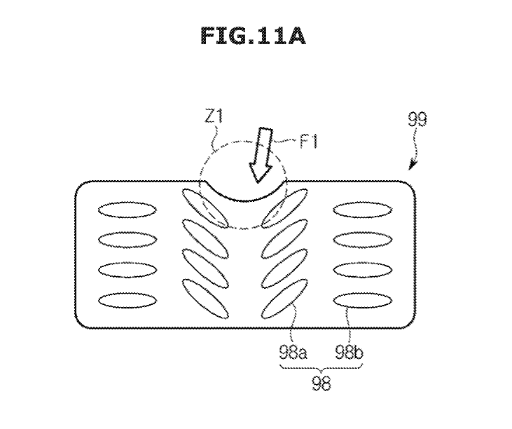

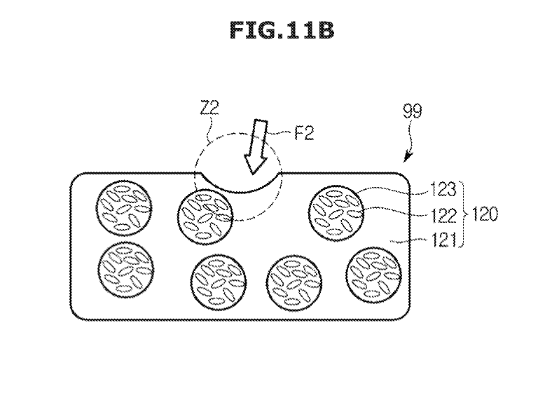

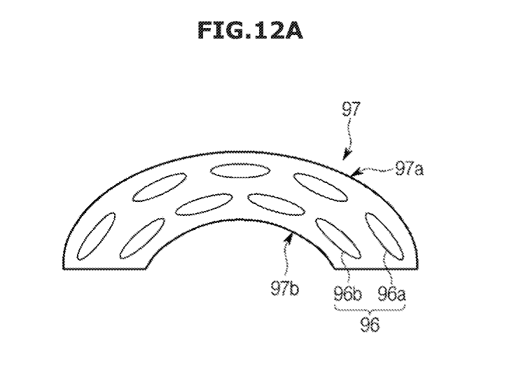

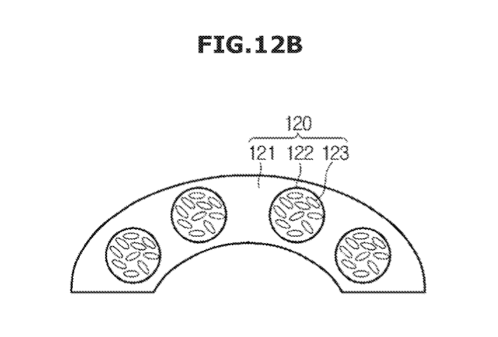

Effects of the display panel 100 will hereinafter be described with reference to FIGS. 11A to 12B.

FIG. 11A is a conceptual diagram illustrating a situation in which external pressure is applied to a conventional display panel. FIG. 11B is a conceptual diagram illustrating a situation in which external pressure is applied to a display panel including a liquid crystal capsule.

Referring to FIG. 11A, liquid crystal molecules 98 of one group may be arranged in the shape of a plurality of columns and provided in the liquid crystal layer 99 of the conventional display panel, and the liquid crystal modules 98 may be arranged in a line shape or a spiral shape according to the received electric field. In this case, assuming that external pressure F1 is applied to one region Z1 of the liquid crystal layer 99 of the display panel, one region Z1 of the liquid crystal layer 99 having received the external pressure F1 may be recessed inward. In this case, the direction of the liquid crystal molecules 98a located in the vicinity of the recessed region Z1 may be twisted according to the external pressure F1, such that arrangement of the liquid crystal molecules 98a is changed. Therefore, arrangement of the liquid crystal molecules 98a located in the vicinity of the recessed region Z1 may be different from arrangement of the liquid crystal molecules 98b located in the other region. The arrangement change of the liquid crystal molecules 98a may cause the occurrence of leakage of light in the display panel. Therefore, expression performance of shadow parts of the images displayed on the display panel may be deteriorated. In contrast, as shown in FIG. 11B, in the case of using the display panel including the liquid crystal capsule layer 120 in which the liquid crystal capsules 122 are distributed in the polymer matrix 121, although the external pressure F2 is applied to the liquid crystal capsule layer 120 of the display panel, the liquid crystal molecules 123 are protected in each liquid crystal capsule 122, such that arrangement of the liquid crystal molecules 123 remains unchanged. Therefore, although the external pressure F2 occurs, the above-mentioned light leakage does not occur, such that optical characteristics of the display panel remain unchanged.

FIG. 12A is a view illustrating a curved state of a conventional display panel. FIG. 12B is a view illustrating a curved state of a display panel including a liquid crystal capsule.

Referring to FIG. 12A, assuming that the display panel is curved or bendable in the same manner as in the flexible display panel, the liquid crystal layer 97 may also be curved according to the degree of curvature of the display panel. If the liquid crystal layer 97 is curved, a curvature of one surface of the liquid crystal layer 97 may be different from a curvature of the other surface of the liquid crystal layer 97, such that different distances may be achieved between the liquid crystal molecules 96 contained in the liquid crystal layer 97. In other words, the distance between the liquid crystal molecules 96a adjacent to the outer surface 97a of the liquid crystal layer 97 may be longer than the distance between the liquid crystal molecules 96b adjacent to the inner surface 97b. Therefore, it is difficult to maintain a constant distance between the liquid crystal molecules 96. In contrast, as shown in FIG. 12B, in the case of using the display panel including the liquid crystal capsule layer 120 in which the liquid crystal capsules 122 are distributed in the polymer matrix 121, the liquid crystal molecules 123 are distributed in each liquid crystal capsule 122, such that the distance between the liquid crystal molecules 123 may remain in a relatively small range even when the liquid crystal capsule layer 120 is curved. Therefore, the distance between the liquid crystal molecules 123 need not be considered, such that the curved display panel or the flexible display panel may be more easily manufactured.

Light emitted from the backlight unit 200 may be incident upon the display panel 100. In more detail, a predetermined-colored light emitted from the backlight unit 200 may be incident upon one surface of the backward direction of the second polarization unit 118 of the display panel 100.

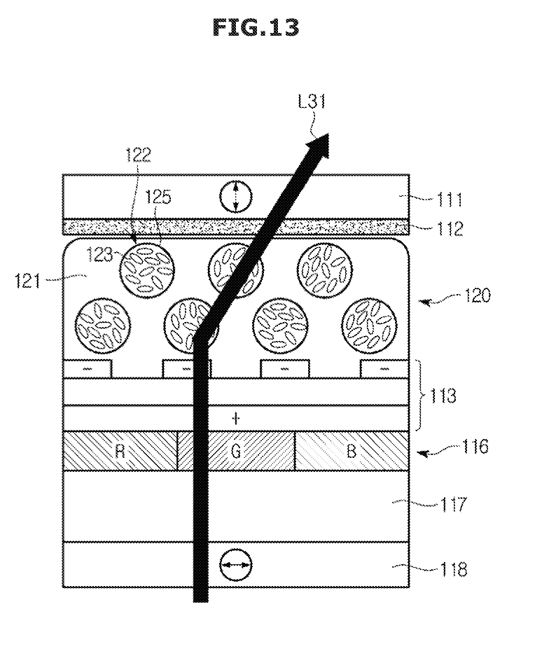

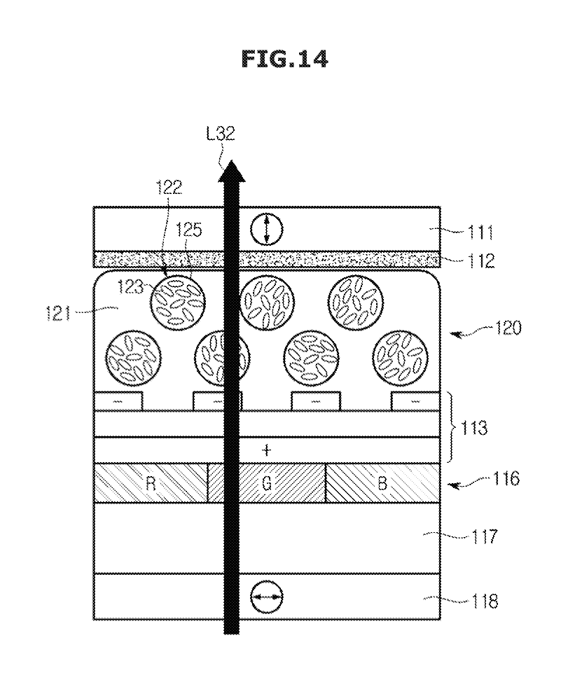

FIG. 13 is a conceptual diagram illustrating that leakage of light caused by a difference in refractive index occurs. FIG. 14 is a conceptual diagram illustrating that no leakage of light occurs due to reduction of a difference in refractive index.

A refractive index (n_c) of the liquid crystal molecules 123 contained in the liquid crystal capsule 122, a refractive index (n_w) of the capsule outer wall layer 125 enclosing the liquid crystal molecules 123, and a refractive index (n_m) of the polymer matrix 121 may be different from one another.

In this case, a difference (|n_c−n_w|) between the refractive index (n_c) of the liquid crystal molecules 123 and the refractive index (n_w) of the capsule outer wall layer 125, a difference (|n_w−n_m|) between the refractive index (n_w) of the capsule outer wall layer 125 and the refractive index (n_m) of the polymer matrix 121, and/or a difference (|n_c−n_m|) between the refractive index (n_c) of the liquid crystal molecules 123 and the refractive index (n_m) of the polymer matrix 121 may be at a considerably high value. As described above, assuming that the difference (|n_c−n_w|, |n_c−n_m| or |n_w−n_m|) between the refractive indexes is at a considerably high value, after light is emitted from the backlight unit 200, the emitted light passes through the second polarization unit 118, the substrate 117, the color change unit 116, and the electrode layer 113, such that the resultant light is refracted according to the above-mentioned difference (|n_c−n_w|, |n_c−n_m| or |n_w−n_m|) in refractive index. As a result, light leakage may occur in the display panel 100, for example, in the vicinity of the border of the display panel 100.

In accordance with one exemplary embodiment, in order to prevent the occurrence of such light leakage, the liquid crystal molecule 123, the capsule outer wall layer 125, and the polymer matrix 121 may be implemented using a specific material through which a difference in refractive index among the polymer matrix 121, the liquid crystal molecule 123, and the capsule outer wall layer 125 is set to 0.1 or less. In more detail, the specific material may allow the difference between two refractive indexes selected from among the above-mentioned three refractive indexes (n_c, n_w, n_m) to be set to 0.1 or less.

In other words, the difference (|n_c−n_w|) between the refractive index (n_c) of the liquid crystal molecules 123 and the refractive index (n_w) of the capsule outer wall layer 125 may be less than 0.1, and the difference (|n_w−n_m|) between the refractive index (n_w) of the capsule outer wall layer 125 and the refractive index (n_m) of the polymer matrix 121 may also be less than 0.1. In addition, the difference (|n_c−n_m|) between the refractive index (n_c) of the liquid crystal molecules 123 and the refractive index (n_m) of the polymer matrix 121 may also be less than 0.1.

For example, assuming that the polymer matrix 121 is formed of polyvinyl alcohol having a refractive index of about 1.5, the capsule outer wall layer 125 and the liquid crystal molecules 123 may be formed of various materials, each of which has a refractive index of about 1.4 to 1.6.

As described above, assuming that a difference between two refractive indexes from among three refractive indexes (n_c, n_w, n_m) of the liquid crystal molecule 123, the capsule outer wall layer 125, and the polymer matrix 121 is equal to or higher than 0.1, the incident light L32 may be less refracted or may be little refracted as shown in FIG. 14, such that such light leakage may not occur in the display panel 100.

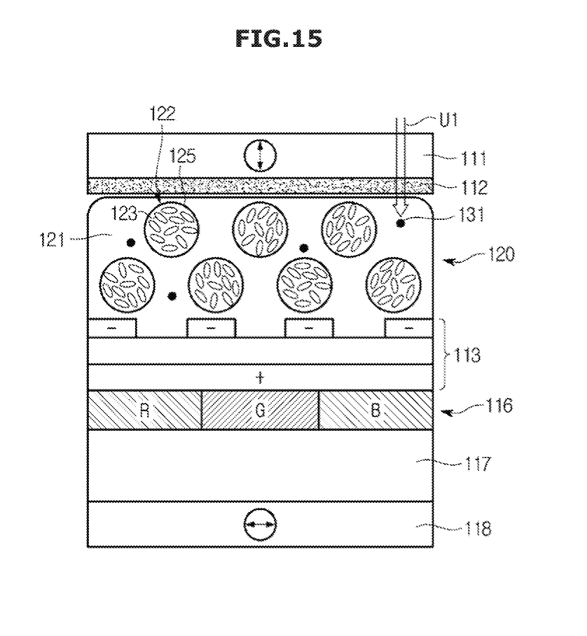

FIG. 15 is a side cross-sectional view illustrating an example of a display panel further including UV absorbent according to an exemplary embodiment of the present disclosure.

Referring to FIG. 15, the display panel 100 may include the first polarization unit 111, the liquid-crystal-capsule-layer protection unit 112, the liquid crystal capsule layer 120, the electrode layer 113, the color change unit 116, the substrate 117, and the second polarization unit 118. In this case, the liquid crystal capsule layer 120 may include the polymer matrix 121, and may also include the liquid crystal capsules 122 distributed in the polymer matrix 121 at random or according to a predetermined pattern. A detailed description thereof has already been given, and as such a detailed description thereof will herein be omitted.

In accordance with one exemplary embodiment, not only the liquid crystal capsule 122 but also the UV absorbent 131 may be distributed in the polymer matrix 121, as shown in FIG. 15.

The UV absorbent 131 may absorb all or some of UV light (U1) incident from the outside to the inside of the liquid crystal capsule layer 120 of the display panel. For example, the UV absorbent 131 may absorb light having a wavelength of about 400 nm or less. The UV absorbent 131 may be configured in the shape of powders or particles.

Referring to FIG. 15, the UV absorbent 131 may be distributed in the polymer matrix 121 at random or according to a predetermined pattern.

The UV absorbent 131 may be inserted in or added to the polymer matrix 121 before the liquid crystal capsule layer 120 is applied to the electrode layer 113 and/or the substrate 117. Alternatively, after the liquid crystal capsule layer 120 is applied to the electrode layer 113 and/or the substrate 117, the UV absorbent 131 may be inserted into the polymer matrix 121. When the liquid crystal capsules 122 are implanted in the polymer matrix 121, the UV absorbent 131 may be simultaneously or sequentially inserted into the polymer matrix 121. In this case, the UV absorbent 131 may be inserted in or added to the polymer matrix 121 in such a manner that the weight of the inserted or added UV absorbent 131 may have a specific gravity of about 1% or less of the entire weight of the liquid crystal capsule layer 120.

After the UV absorbent 131 is inserted in or added to the polymer matrix 121, ultrasonic waves or the like may be applied to the polymer matrix 121. In this case, the UV absorbent 131 may vibrate or move by the applied ultrasonic waves, and at the same time may be uniformly distributed in the liquid crystal capsule layer 121.

The UV absorbent 131 may be implemented using various materials which can absorb UV light or can be optionally selected by the designer. For example, the UV absorbent 131 may be implemented using a benzotriazole-based UV absorbent, a triazine-based UV absorbent, an oxalanilide-based UV absorbent, and/or a benzophenone-based UV absorbent.

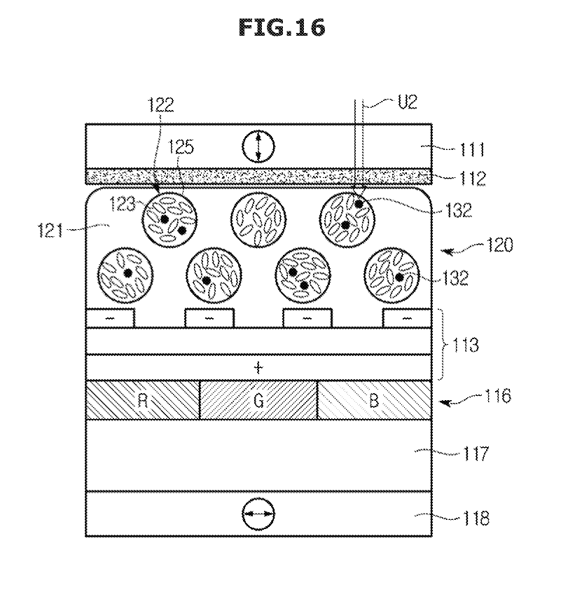

FIG. 16 is a side cross-sectional view illustrating an example of a display panel further including UV absorbent according to another exemplary embodiment of the present disclosure.

Referring to FIG. 16, the UV absorbent 131 may be scattered and present in each liquid crystal capsule 122. In this case, the UV absorbent 132 may be present in some of the plurality of liquid crystal capsules 122 contained in the polymer matrix 121, or may not be present in some other liquid crystal capsules. In addition, the amounts of UV absorbent 132 distributed in the respective liquid crystal capsules 122 may be different from each other. That is, the number of particles of the UV absorbent 132 present in some liquid crystal capsules 122 may be higher than the number of particles of the UV absorbent 132 present in some other liquid crystal capsules 122. Of course, the amounts of UV absorbent 132 distributed in the respective liquid crystal capsules 122 may be approximately identical or similar to one another.

In the same manner as described above, the UV absorbent 132 contained in the liquid crystal capsules 122 may absorb all or some of UV light (U2) incident from the outside to the inside of the liquid crystal capsule layer 120 of the display panel. For example, the UV absorbent 132 may absorb light having a wavelength of about 400 nm or less.

In accordance with one exemplary embodiment, when the liquid crystal molecules 123 are configured in the shape of a capsule, the UV absorbent 132 along with the liquid crystal molecules 123 may be enclosed by the capsule outer wall layer 125, such that the UV absorbent 132 may be inserted in the liquid crystal capsule 122. In accordance with another exemplary embodiment, after the liquid crystal molecules 123 are configured in a capsule shape and the liquid crystal capsule 122 is then formed, the liquid crystal molecules 123 may be additionally inserted in the liquid crystal capsule 122, such that the liquid crystal molecules 123 may be present in the liquid crystal capsule 122.

The UV absorbent 132 inserted in the liquid crystal capsule 122 may be implemented as various materials capable of absorbing UV light in the same manner as in the UV absorbent 131 inserted into the polymer matrix 121. For example, the UV absorbent 132 may be implemented using a benzotriazole-based UV absorbent, a triazine-based UV absorbent, an oxalanilide-based UV absorbent, and/or a benzophenone-based UV absorbent.

Although FIGS. 15 and 16 have exemplarily disclosed that the UV absorbent 131 or 132 may be present in any one of the polymer matrix 121 and the liquid crystal capsule 122, the scope or spirit of the present disclosure is not limited thereto, and the UV absorbent 131 or 132 may also be present or distributed in both the polymer matrix 121 and each liquid crystal capsule 122 as necessary. In addition, the UV absorbent 131 or 132 may also be present in the remaining parts other than the polymer matrix 121 and the liquid crystal capsules 122 according to selection of the designer. If the UV absorbents (131, 132) are present in both the polymer matrix 121 and the liquid crystal capsules 122, the UV absorbent 131 contained in the polymer matrix 121 and the UV absorbent 132 contained in the liquid crystal capsules 122 may also be implemented using a homogeneous material or a heterogeneous material.

Referring to FIGS. 3 and 4, the backlight unit 200 may include an optical plate 210, a diffusion plate 220, a reflective plate 230, and a light emitting unit 240. Some parts from among the above-mentioned constituent components may be omitted or may be replaced with other elements according to exemplary embodiments.

The light emitting unit 240 may include a substrate 241, and may further include a light source 242 populated onto the substrate 241 to emit light. The substrate 241 may be configured in the shape of a planar plate or a bar, and at least one light source 242 may be populated thereon. For example, a plurality of light sources 242 may be arranged in a line or in various patterns over a single substrate 241, and the resultant light source may be populated onto the single substrate 241. Alternatively, only one light source 242 may also be populated onto the single substrate 241. A drive power-supply line (or the like) for supplying a drive power-supply signal to the light source 242 may be formed in the substrate 241, such that a signal cable (not shown) and a backlight drive circuit (not shown) may be connected to the substrate 241 through the drive power-supply line or the like. The substrate 241 may be formed of various materials such as a synthetic resin or the like, or may be formed of a transparent material such as a polymethyl methacrylate resin or glass plate. The display apparatus 100 may include a plurality of substrates 241.

The light sources 242 may be arranged in a predetermined pattern and mounted to the substrate 241, and at least one light source 242 may be provided over the substrate 241. The arrangement pattern of the light sources 242 may be arranged to correspond to the arrangement pattern of the color conversion elements (116a to 116c of FIG. 5) of the color change unit 116 contained in the display panel 100. However, the arrangement pattern of the light sources 242 is not limited thereto, and the light sources 242 may be arranged over the substrate 241 in various patterns capable of being considered by the designer.

The light sources 242 may emit predetermined-colored light in various directions. In this case, the predetermined-colored light may include white-based light or blue-based light. The white-based light may be generated by mixture of a plurality of light signals having different wavelengths, and may indicate the visibly white-colored light or the approximately white colored light. The blue-based light may have a wavelength of about 400 nm to 500 nm, and may indicate the visibly blue-colored light or the approximately blue colored light.

For example, the light sources 242 may be implemented using an incalescent lamp (light bulb), a halogen lamp, a fluorescent lamp, a sodium lamp, a mercury lamp, a fluorescent mercury lamp, a xenon lamp, an arc light, a neon-tube lamp, an EL lamp, an LED light, or the like. Additionally, various kinds of light emitting units capable of being considered by the designer may also be used as the light sources 242.

Light emitted from the light sources 242 may be directly emitted in the forward direction (i.e., the direction of the display panel 100), or may be reflected from the reflective plate 230 and then emitted in the forward direction.

The reflective plate 230 may be installed at the inside of the rear housing 12, and may reflect the light, which has been emitted from the light sources 242 in the backward direction (back-surface direction), the lateral direction, or the backward lateral direction, in either the forward direction (front-surface direction) or another direction corresponding to the forward direction.

In accordance with one exemplary embodiment, at least one through-hole 232 in which each of the light sources 242 is inserted and installed may be provided in the reflective plate 230. The light source 242 may be inserted into the through-hole from the back-surface direction of the reflective plate 230, and may be exposed in the direction of the reflective surface 231. Needless to say, the through-hole 232 may not be formed in the reflective plate 230 according to the exemplary embodiments. In this case, the light sources 242 may be provided over a separate substrate (not shown) installed over the reflective surface 231 of the reflective plate 230. In more detail, the light sources may be mounted to one surface of the forward direction of the separate substrate. The separate substrate may be formed of a transparent material through which light passes.

The reflective plate 230 may also be formed of a synthetic resin such as a polycarbonate or a polyethylene terephthalate. In addition, the reflective plate 230 may also be formed of various metal materials. The reflective plate 230 may also be formed of various materials selectable by designer.

In accordance with one exemplary embodiment, at least one optical plate 210 and at least one diffusion plate 220 may be provided in the forward direction of the reflective plate 230. Respective sheets 211 to 213 of the optical plate 210 and the diffusion plate 220 may be stacked.

Light emitted from the light sources 242 or reflected from the reflective plate 230 may be incident upon at least one diffusion plate 220. The diffusion plate 220 may be used to diffuse the incident light. The diffusion plate 220 may diffuse the incident light from the light sources 242 such that the light can be evenly dispersed in all regions of the display panel 100. If necessary, the diffusion plate 220 may also be omitted. The light having passed through the diffusion plate 220 after having been emitted from the light sources 242 may be incident upon the optical plate 210.

The optical plate 210 may diffuse the incident light or may protect various kinds of sheets. The optical plate 210 may be formed of a stacked structure of one or more sheets. For example, the optical plate 210 may include at least one protective sheet 211, at least one prism sheet 212, and at least one diffusion sheet 213. Each of the protective sheet 211, the prism sheet 212, and the diffusion sheet 213 may be formed in a film shape.

The protective sheet 211 may be adjacent to the second polarization unit 118, and may protect constituent elements, for example, the prism sheet 212 or the diffusion sheet 213, from external stimulus or foreign materials.

The prism sheet 212 may refract the diffused light received from the diffusion sheet 213, such that the resultant light is incident upon the second polarization unit 118 of the display panel 100. A plurality of prisms may be arranged over one surface of the prism sheet 212. In accordance with one exemplary embodiment, the display apparatus 10 may include a plurality of prism sheets 212 therein.

The diffusion sheet 213 may offset the pattern of the above-mentioned diffusion plate 220. If light scattered by the diffusion plate 220 directly arrives at the user's eyes, the pattern formed in the diffusion plate 220 appears unchanged, such that the diffusion sheet 213 may offset or minimize the pattern of the diffusion plate 220.

As described above, the optical plate 210 may include a single protective sheet 211, a single diffusion sheet 213, and a prism sheet 212. The optical plate 210 may not include at least one of the single protective sheet 211, the single diffusion sheet 213, and the single prism sheet 212. Furthermore, the optical plate 210 may include many more sheets. In addition, the optical plate 210 may include a complex sheet in which functions of respective sheets (211 to 213) are mixed. In accordance with one exemplary embodiment, the optical plate 210 may be omitted as necessary.

The light having passed through the optical plate 210 may be incident upon one surface of the back-surface direction (backward direction) of the display panel 100. In more detail, the above light may be incident upon the second polarization unit 118.

An intermediate housing 13 may be disposed between the optical plate 210 and the second polarization unit 118. The intermediate housing may fix the backlight unit 120 or may separate the display panel 110 and the backlight unit 120 from each other. The intermediate housing 13 may include protrusions formed to protrude in the direction of the display panel 110 and the backlight unit 120, and may fix the backlight unit 120 using the protrusions. The intermediate housing 13 may be integrated with the front housing 11 or the rear housing 12. If necessary, the intermediate housing 13 may also be omitted according to exemplary embodiments as necessary.

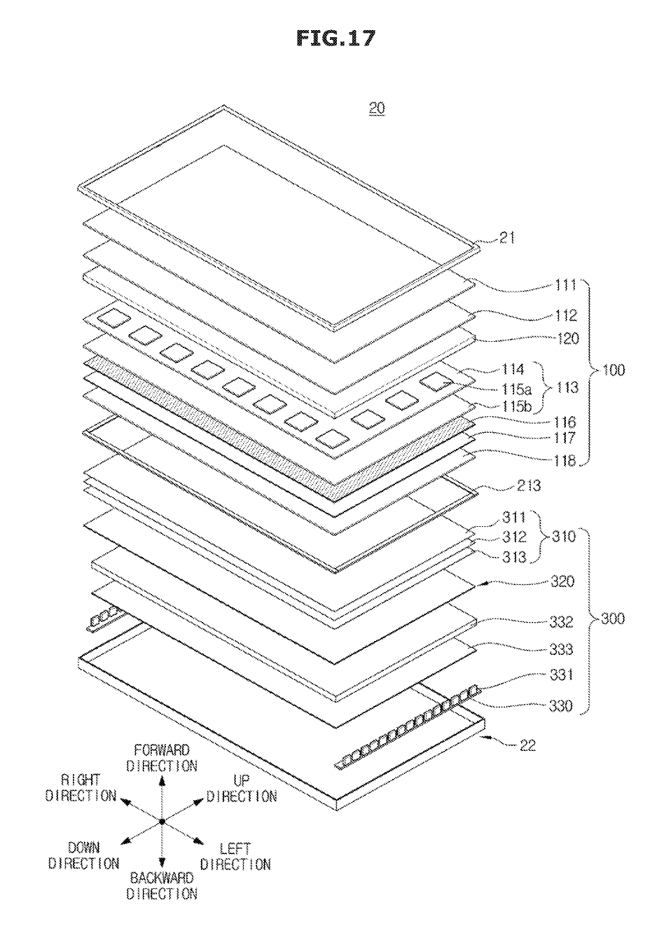

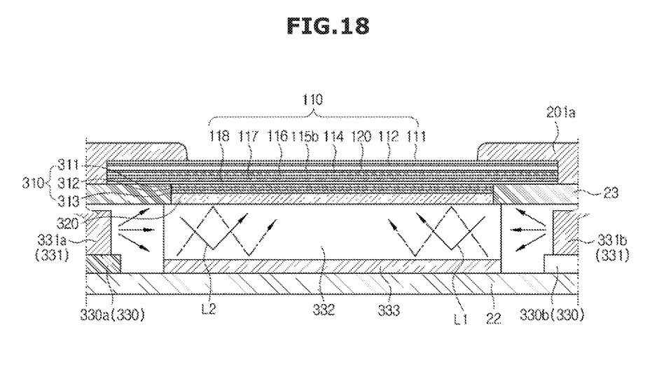

FIG. 17 is an exploded perspective view illustrating a display apparatus according to another exemplary embodiment of the present disclosure. FIG. 18 is a side cross-sectional view illustrating a display apparatus according to another exemplary embodiment of the present disclosure.

Referring to FIGS. 17 and 18, the display apparatus 20 according to another exemplary embodiment may include housings (21, 22, 23) to form the external appearance thereof, the display panel 100 to generate images, and the backlight unit 300 to provide the display panel 100 with light.

The housings (21, 22) may be classified into a front housing 21 installed in the front-surface direction (forward direction) and a rear housing 22 installed in the back-surface direction (backward direction). In accordance with the exemplary embodiments, the display apparatus 20 may further include an intermediate housing 23.

The front housing 21, the rear housing 22, and the intermediate housing 23 have already been given in FIGS. 3 and 4, and as such a detailed description thereof will herein be omitted for convenience of description.

The display panel 100 may include a first polarization unit 111, a liquid-crystal-capsule-layer protection unit 112, a liquid crystal capsule layer 120, an electrode layer 113, a color change unit 116, a substrate 117, and a second polarization unit 118. The electrode layer 113 may include an insulation substrate 114, a pixel electrode 115a, and a common electrode 115b. In accordance with one exemplary embodiment, some parts from among the above-mentioned constituent components may be omitted or may be replaced with other elements.

The liquid capsule layer 120 may include a polymer matrix and liquid crystal capsules distributed in the polymer matrix as described above. Each liquid crystal capsule may include liquid crystal molecules aligned according to the electric field, and a capsule outer wall layer including the liquid crystal molecules. If necessary, the liquid crystal capsule may further include a surfactant (interfacial active agent) therein.

The first polarization unit 111, the liquid-crystal-capsule-layer protection unit 112, the liquid crystal capsule layer 120, the electrode layer 113, the insulation substrate 114, the pixel electrode 115a, the common electrode 115b, the color change unit 116, the substrate 117, the second polarization unit 118, and liquid crystal capsules contained in the liquid crystal capsule layer 120 have already been given in FIGS. 3 to 12, and as such a detailed description thereof will herein be omitted for convenience of description.

The backlight unit 300 may include an optical plate 310, a diffusion plate 320, a substrate 330, light sources 331, a light guide plate 332, and a reflective plate 333.

The substrate 330 may be formed in a manner that at least one light source 331 is populated onto one surface thereof. The substrate 330 may support at least one light source 331, and may include a drive power-supply line configured to provide the light sources 331 with the drive power. The substrate 330 may be manufactured using a synthetic resin or the like. The substrates (330a, 330b) may be formed at the left side and the right sides on the basis of the light guide plate 332.

One or more light sources 331 may be arranged in a predetermined pattern over one surface of the substrate 300, and then populated onto the surface of the substrate 300. The light sources 331 may emit predetermined colored light, and the emitted light may be incident upon the side surface of the light guide plate 332. In this case, the predetermined color may include white-based light or blue-based light.

At least one light source 242 may be implemented using various kinds of light emitting units, for example, an incandescent lamp (light bulb), a halogen lamp, a fluorescent lamp, a sodium lamp, a mercury lamp, a fluorescent mercury lamp, a xenon lamp, an arc light, a neon-tube lamp, an EL lamp, an LED light, or the like.

One or more light sources (331a, 331b) may be disposed at both sides of the light guide plate 332 in a manner that light is emitted from both sides of the light guide plate 332. In this case, the light sources (331a, 331b) arranged in a predetermined pattern may be respectively populated onto the left substrate 330a and the right substrate 330b of the light guide plate 332.

Light emitted from the respective light sources (331, 331a, 331b) may be incident on the light guide plate 332 through the side surface of the light guide plate 332, as denoted by L1 and L2. The light emitted into the light guide plate 332 may be totally reflected and move in the light guide plate 332, such that light can be evenly incident upon one surface of the display panel 100.

The light guide plate 332 may be configured to reflect light (L1 or L2) emitted from the light sources 331 at least once, and the light emitted from the light sources 331 may be evenly provided to all regions of the display panel 210. The display panel 110, the diffusion plate 330, or the optical plate 310 may be arranged to contact or neighbor one surface of the forward direction of the light guide plate 332, and the reflective plate 333 may be attached to one surface of the backward direction of the light guide plate 232. The light guide plate 332 may be formed of a material having high optical transmittance, for example, a polymethyl methacrylate resin or the like.

The reflective plate 333 may reflect one light emitted in the backward direction from among the light signals (L1, L2) moving in the light guide plate 332, in the forward direction (i.e., the direction of the display panel 100). Therefore, light emitted from the light sources 331 may be generally incident upon the display panel 100. The reflective plate 322 may be formed of a synthetic resin, for example, polyethylene terephthalate or polycarbonate. Further, the reflective plate 333 may also be formed of various materials selectable by the designer.

At least one of the optical plate 310 and the diffusion plate 320 may be disposed between the display panel 110 and the light guide plate 332. The optical plate 310 may be formed of a stacked structure of at least one protective sheet 211, at least one prism sheet 212, and at least one diffusion sheet 213. The optical plate 310 and the diffusion plate 320 may also be omitted according to exemplary embodiments. If necessary, the optical plate 310 and the diffusion plate 320 may also be replaced with another film or substrate. The diffusion plate 320 and the optical plate 310 have already been disclosed, and as such a detailed description thereof will herein be omitted.

The light having passed through the optical plate 310 and the diffusion plate 320 may be incident through one surface of the backward direction of the display panel 100. As described above, the light may be emitted to the outside through the second polarization unit 118, the substrate 117, the color change unit 116, the electrode layer 113, the liquid crystal capsule layer 120, and the first polarization unit 111. Therefore, still images or moving images may be displayed on the display panel 100.

As is apparent from the above description, the display panel and the display apparatus according to the exemplary embodiments can implement a display panel using a relatively small number of substrates, and can simplify the production process, resulting in reduction of production costs.

The display panel and the display apparatus according to the exemplary embodiments do not change arrangement of liquid crystals contained in the display panel by external pressure caused by user's touch or external impact, such that optical characteristics remain unchanged. As a result, desired qualities of the display panel and the display device can be remained.

In accordance with the display panel and the display apparatus, a single substrate is used even when a curved display panel or a flexible display panel is manufactured, such that a substrate having a very small curvature can be implemented. In the case of using a plurality of substrates, the exemplary embodiments can implement a constant curvature in a different way from the conventional display in which curvatures of plural substrates cross each other.

In accordance with the display panel and the display apparatus, an alignment layer or sealant need not be used, such that the manufacturing process of the display panel and the display apparatus is simplified, resulting in reduction of production costs.

In accordance with the display panel and the display apparatus, since ultraviolet (UV) light generated from daily life is absorbed by a UV absorbent, liquid crystal is prevented from being affected by UV light or UV influence upon liquid crystal can be minimized.

The display panel and the display apparatus according to the exemplary embodiments can minimize a difference in refractive index between various materials (e.g., liquid crystal capsule, liquid crystal molecule, and polymer matrix) contained in the display panel, such that leakage of light from the display panel can be prevented.

Although a few exemplary embodiments of the present disclosure have been shown and described, it would be appreciated by those skilled in the art that changes may be made in these exemplary embodiments without departing from the principles and spirit of the present disclosure, the scope of which is defined in the claims and their equivalents.

What is claimed is:

1. A display panel comprising:
a liquid crystal capsule layer in which a plurality of liquid crystal capsules are distributed, each of the plurality of liquid crystal capsules including liquid crystal molecules; and
an electrode unit disposed at one surface of the liquid crystal capsule layer and configured to form an electric field in the liquid crystal capsule layer,
wherein a thickness of the liquid crystal capsule layer exceeds half a ratio of a wavelength of incident light to a birefringence value of the liquid crystal molecules.

2. The display panel according to claim 1, wherein each of the plurality of liquid crystal capsules includes:
an outer wall layer to form an external appearance of a capsule; and
liquid crystal molecules distributed in the outer wall layer and aligned according to an electric field.

3. The display panel according to claim 2, wherein each of the plurality of liquid crystal capsules further includes:
an interfacial active agent to facilitate alignment of the liquid crystal molecules.

4. The display panel according to claim 2, wherein the liquid crystal capsule layer includes a polymer matrix in which the plurality of liquid crystal capsules are distributed.

5. The display panel according to claim 4, wherein:
a difference in refractive index between at least two of the outer wall layer, the liquid crystal molecules, and the polymer matrix is equal to or less than 0.1.

6. The display panel according to claim 1, further comprising:
a color change unit configured to change a color of the incident light.

7. The display panel according to claim 6, wherein:
the electrode unit is disposed between the liquid crystal capsule layer and the color change unit, or
the color change unit is disposed between the liquid crystal layer and the electrode unit.

8. The display panel according to claim 6, further comprising:
a substrate in which the electrode unit or the color change unit is seated.

9. The display panel according to claim 8, wherein the substrate includes a rigid substrate, a flexible substrate, or a rigid-flexible substrate.

10. The display panel according to claim 1, wherein the electrode unit includes:
a plurality of pixel electrodes arranged in a direction of the liquid crystal capsule layer;
an insulation substrate in which the pixel electrodes are arranged at one surface of the insulation substrate; and
a common electrode arranged at the other surface of the insulation substrate.

11. The display panel according to claim 1, further comprising:
a liquid-crystal-capsule-layer protection unit disposed at one surface of the liquid crystal capsule layer.

12. The display panel according to claim 1, wherein each of the liquid crystal molecules includes a positive liquid crystal molecule.

13. The display panel according to claim 1, wherein:
if the electrode unit forms an electric field in the liquid crystal capsule layer, liquid crystal molecules of some liquid crystal capsules arranged in the direction of the electrode unit from among the plurality of liquid crystal capsules are aligned, and liquid crystal molecules of some other liquid crystal capsules from among the plurality of liquid crystal capsules are not aligned.

14. A display apparatus comprising:
a display panel configured to display images; and
a backlight unit configured to provide the display panel with light,
wherein the display panel includes
a liquid crystal capsule layer in which a plurality of liquid crystal capsules are distributed, each of the plurality of liquid crystal capsules including liquid crystal molecules; and
an electrode unit disposed at one surface of the liquid crystal capsule layer and configured to form an electric field in the liquid crystal capsule layer,
wherein a thickness of the liquid crystal capsule layer exceeds half a ratio of a wavelength of incident light to a bi-refraction value of the liquid crystal molecules.

15. The display apparatus according to claim 14, wherein each of the plurality of liquid crystal capsules includes:
an outer wall layer to form external appearance of a capsule; and
liquid crystal molecules distributed in the outer wall layer and aligned according to an electric field.

16. The display apparatus according to claim 15, wherein each of the plurality of liquid crystal capsules further includes:
an interfacial active agent to facilitate alignment of the liquid crystal molecules.

17. The display apparatus according to claim 14, wherein the liquid crystal capsule layer includes a polymer matrix in which the plurality of liquid crystal capsules are distributed.

18. The display apparatus according to claim 14, wherein the display panel further includes a substrate in which the electrode unit is seated,
wherein the substrate includes a rigid substrate, a flexible substrate, or a rigid-flexible substrate.

19. The display apparatus according to claim 14, wherein the backlight unit includes:
at least one light source; and
a light guide plate in which light emitted from the at least one light source is incident upon a side surface of the light guide plate and is emitted in a direction of the display panel through one surface of the light guide plate.

20. The display apparatus according to claim 14, wherein the backlight unit includes:
at least one light source; and
a substrate in which the at least one light source is installed at one surface of a direction of the display panel.
